(19) United States
(12) Patent Application Publication
(10) Pub. No.: US 2012/0272968 A1
(43) Pub. Date: Nov. 1, 2012

(54) DISPOSABLE OUTDOORS MASK AND METHOD OF USE

(75) Inventor: Garry William KIRSCHNER, London (CA)

(73) Assignee: KIRSCHNER SAFETY PRODUCTS INC., London (CA)

(21) Appl. No.: 13/539,926

(22) Filed: Jul. 2, 2012

Related U.S. Application Data
(63) Continuation of application No. 12/153,606, filed on May 21, 2008.
(60) Provisional application No. 60/984,575, filed on Nov. 1, 2007.

(51) Int. Cl. A62B 23/00; A42B 1/18; A41D 13/11

(52) U.S. Cl. 128/206.13; 2/206

(57) ABSTRACT

A mask designed to be worn to cover the mouth of a user comprises an inner and exterior layers, with an odor adsorbing layer and a filter layer disposed between the inner and exterior layer. The filter layer is positioned between the inner layer and odor adsorbing layer to prevent or minimize entry of unwanted particulate matter into the user's mouth. Once the mask is used to its fullest, it can be thrown away since it is constructed to be sufficiently low in cost so that it can be disposed and another one used the next time odor and particulate filtering is needed.

### FIELD OF THE INVENTION

The present invention relates, in one aspect to disposable outdoors masks and more specifically to odor adsorbing masks that include a filter to prevent or minimize inhalation of harmful substances when wearing the mask.

### BACKGROUND

A common tactic when hunting wild game is to go undetected from the game which is being hunted. This is commonly done by using stealthy movements and/or by remaining stationary in an observing position. A hunter may further hide themselves by blending in with the natural cover and wearing a camouflage jacket and pants.

As wild game tend to have an enhanced sense of smell, advanced hunters may position themselves downwind of their prey in an attempt to mask their odour from the prey so that there is little warning of their presence. This can be difficult though as the wind can change direction, there may be little to no wind thereby rendering this tactic substantially useless, or can be difficult or impossible due to the layout of the terrain. Additionally, it can be very difficult to mask the odor given off from the hunter due to breathing.

One option for minimizing the effect of odor due to breathing is through the use of a garment worn over the mouth. Some garments contain a charcoal filter for filtering out incoming odors from the hunter. These garments are however expensive and can be very difficult or impossible to clean, neutralize or reactivate the filter in the garment. This is especially the case when an activated charcoal filter is used and the charcoal filter can require heating to over 600° C. to release the adsorbed molecules. Heating of the garment to the required temperature is difficult and therefore once saturated they will not be able to release the adsorbed odors at clothes dryer temperatures. A further problem with these garments is that they adsorb the odor from the surrounding area and therefore become less effective even during storage as they adsorb the odor from the environment in which they are stored. This results in greatly reduced effectiveness. Washing and drying of the garments also leads to the deterioration of the garment itself. These garments may also be intrusive for hunter wearing the garment. These garments also typically form part of a larger outfit which is expensive and can be awkward.

A further problem associated with hunting is the risk of catching disease from an animal once it has been killed and a hunter is moving, preparing or cleaning the killed animal. This includes bacteria which a hunter can be exposed to when preparing, cleaning and/or transporting game.

A need therefore exists for a device for blocking a hunter's breath odor which overcomes at least one of the problems associated with such a device or one of the problems outlined above.

U.S. Pat. No. 6,070,578 to Baughman discloses an odor eliminator mask that used activated carbon for odor control. One problem with Baughman is that the mask is essentially a piece of clothing similar to the carbon-containing clothing as sold by Scent Lok of Muskegon, Mich. This clothing needs to be reactivated for the carbon to properly function over time, and this requirement imposes a burden on the hunter to process the clothing to achieve this aim. Also, the Baughman mask, while adsorbing odors, does not have any provision to deal with other elements in the hunting environment that can be harmful, allergens, disease carrying organisms, and the like. Therefore, there is still a need for improvements to hunting masks designed for odor adsorption.

In addition, the inhalation of carbon particulates can be detrimental over time and this problem presents itself when using the Baughman mask. Inhalation of ultrafine carbon particles has been shown to trigger biphasic pro-inflammation response in mouse lung.

Carbon-containing inserts are disclosed in U.S. Pat. No. 7,260,853 to Newman. Newman proposes a system for clothing with vents, wherein removably attachable inserts containing activated carbon are placed over the vents for odor control. The inserts can be removed and replaced when the odor adsorbing/absorbing quality of the material in the insert decreases. While Newman suggests that the inserts can be replaced, Newman fails to address the problems noted above regarding the inhalation of carbon particulates.

### SUMMARY

An odor adsorbing disposable outdoors mask for adsorbing a user's breath odor is provided. The mask has a number of outdoor uses, including for hunting. When used during hunting, the mask covers the hunter's mouth and adsorbs the odor from the hunter's breath as it is exhaled. The mask comprises an odor adsorbing layer which may be comprised of activated charcoal for adsorbing the hunter's breath odor. The mask may be disposable so that reactivation of the charcoal is unnecessary. The odor adsorbing layer may additionally adsorb particles which would otherwise be inhaled by the hunter thereby blocking odor from game which has been killed and optionally blocking bacteria from being inhaled by the hunter.

One embodiment provides for a hunting mask for adsorbing a hunter's breath odor, the mask comprising:

a camouflage or non-camouflage exterior layer,

an odor adsorbing layer,

one or more filter layers,

an inner layer suitable for placement over a hunter's mouth, and

an attachment strap for securing the hunting mask over the mouth of a hunter.

The invention also includes a number of different uses of the mask, which may or may not relate to hunting. For example, the mask could be for other outdoors activities such as camping or hiking, wherein the outdoors mask could be used to filter water, and this filtering capability may come in handy when just carrying the mask on a hike or camping.

The exterior layer can be patterned and/or colored to environmentally suit the activity the user is engaged in when donning the mask. For example, the exterior layer could have a floral pattern if used for gardening when wanting to minimize the attraction of insects to a user's breath. A myriad of other uses are detailed below in the detailed description of the invention.

### BRIEF DESCRIPTION OF THE DRAWINGS

FIG. 1 is a front view illustrating one embodiment of a hunting mask;

FIG. 2A is a cross sectional view illustrating the layers of one embodiment of a hunting mask; and

FIG. 2B is a cross sectional view illustrating the layers of another embodiment of a hunting mask.

### DETAILED DESCRIPTION

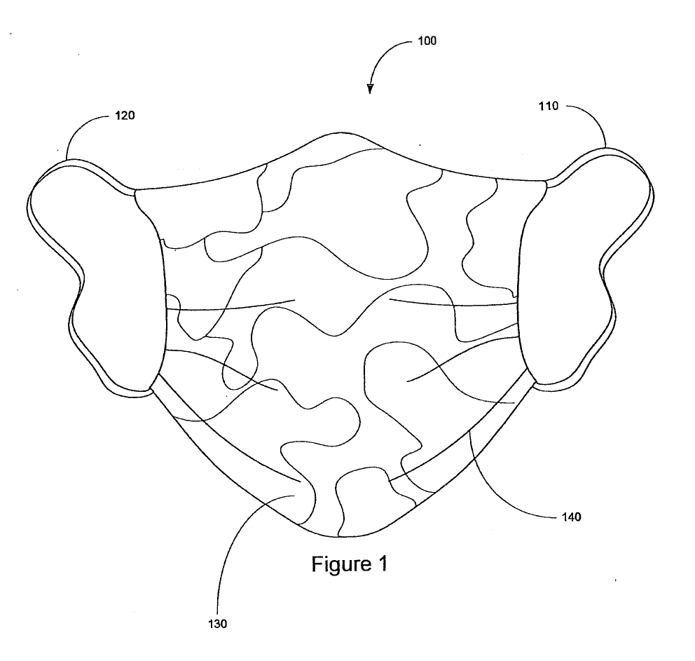

One embodiment of a hunting mask for blocking a hunter's breath odour is shown generally in FIG. 1 at 100. The mask 100 is for use on the head of a hunter for blocking the odor of the breath of the hunter from the wild game or other animals in the area.

The mask 100 is attached to the head of the hunter using attachment straps 110 and 120 connected to each side of the mask 100. The attachment straps may be made of elastomeric material thereby providing a secure fit to the hunter's head by, for example, wrapping around the ears of the hunter. Alternatively, the attachment straps 110 and 120 may simply be tied together around the hunter's head. The straps 110 and 120 may be attached at each end of the strap 110 and 120 to the mask as illustrated in FIG. 1 or alternatively, can comprise of two separate straps attached on each side of the mask 100 for tying to each other. In another embodiment, the straps may be attached to both sides of the mask 100 and may be made of elastomeric material for completely encircling the hunter's head when being worn.

The front of the mask 100 can have a camouflage pattern 130 for disguising the hunter's face.

The mask 100 includes an odor adsorbing device such as activated charcoal (not shown) for blocking the odor of the hunter's breath when exhaled. The odor produced when the hunter breathes is at least partially adsorbed by the odor adsorbing device thereby preventing the wild game or other animals within the vicinity from being alerted to the hunter because of the odor given off by the hunter's breath.

The mask 100 is simple in construction and therefore inexpensive to purchase. As a result, the mask 100 is disposable. This provides an advantage in that it foregoes the need to reactivate the charcoal filter once the filter has been saturated or partially saturated. By using a new mask 100 for each outing, the hunter is ensured maximum efficacy from the mask 100 in preventing their odour from being detected. Reactivation of prior garments was often attempted using a clothes dryer which did not heat the garment sufficiently to properly reactivate the charcoal filter and therefore prior garments became much less useful after each outing and also after storage.

The mask 100 may be sized to fit various sizes of mouth and head. The mask 100 may comprise creases 140 for conforming to the shape of a hunter's head for covering the hunter's chin and at least partially covering the hunter's jaw thereby ensuring ample covering to allow for the odor filter to absorb the odor particles emitted in the hunter's breath.

The mask 100 is useful in both hot and cold environments as the mask only partially covers the face of the hunter. In the event that the environment is cold, a hat or other head gear may additionally be used by the hunter. In the event that the environment is hot, the hunter may simply use the mask 100 without additional head covering.

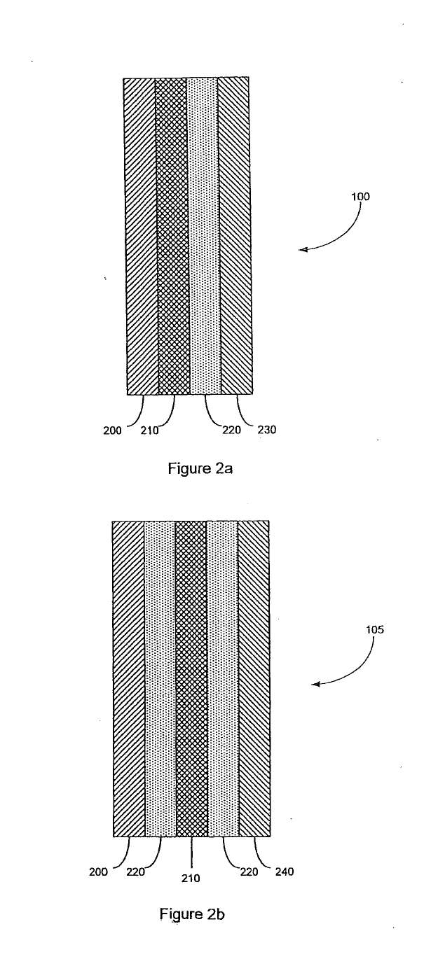

FIG. 2A illustrates the cross-section of one embodiment of a hunting mask 100. The hunting mask 100 is comprised of four layers. An outer camouflage layer 200 forms the exterior layer of the mask. An odor adsorbing layer 210 adsorbs odor and odor causing particles, including bacteria, preventing wild game and animals from detecting the hunter's breath odor. A filter layer 220 filters out particulate matter including some bacteria as small as, for example 3 microns in size. An inner layer 230 forms the interior of the mask 100 and is suitable for placement over the mouth of the hunter.

Using the filter element, particularly a 3 micron filter assists with people who have allergies to certain things, e.g., pollen, ragweed, sage etc., and are sensitive to the outdoors due to pollution (dust) and allergic reactions to field dressing properties, (infectious diseases). By using the 3 micron filter or smaller, hunters are no longer inhaling carbon (such as in found in typical activated carbon containing clothing) which can only be beneficial to the hunter. Also by wearing the 3 micron or smaller filter, breathing filtered fresh air keeps the hunter more alert while sitting in a tree stand thereby making his experience safer (may prevent a fall, etc).

The odor adsorbing layer 210 may include an odor adsorbing agent selected from the group consisting of activated charcoal, chlorophyll, baking soda, activated alumina, soda lime, zeolite, calcium oxide potassium permanganate or a similar substance. The embodiment illustrated in FIG. 2A shows the odor adsorbing layer 210 as an activated charcoal layer suitable for adsorbing odor and odor causing particles. The odor adsorbing layer 210 may also adsorb pollutants from the environment and prevent them from being inhaled by the hunter. One example of an odor adsorbing layer is Zorflex®, which is an activated carbon cloth made by Chemviron Carbon and distributed in the United States by Calgon Carbon Corporation of Pittsburgh Pa.

The inner layer 230 and the outer camouflage layer 200 may be woven or non-woven fabric comprising cotton, wool, polyester, polypropylene, or any suitable fabric. The filter layer 220 may be any material suitable for filtering particulate matter from clogging the odour absorbing layer 210. The filter layer 220 may filter out particulate matter as small as 3 microns in size. This can be useful preventing both the inhalation of small particulate matter including some bacteria and additionally in preventing the clogging of the odour absorbing layer 210 with small particulate matter expelled from the mouth of the hunter.

Reactivation of the activated charcoal filter is unnecessary as the mask 100 may be disposed of after each use. Storage of the mask 100 in an odor free environment between uses is unnecessary as the mask 100 may be disposed of after use. The disposal nature of the mask can be compared to a paper towel or napkin, wherein the item may be used once or only a couple of times before disposing it.

Since the mask is designed to be disposable, one embodiment would have all of the mask materials being totally biodegradable so that if inadvertently left in nature, it would break down safely and quickly, using biological means, into raw materials and disappear into the environment. In this embodiment, the layers could be made of paper, the elastic would be made of fiber, the filter layer could be made out of paper or fiber, and if wires would be employed, they would be the type that would be degradable. The disclosed materials are only examples of biodegradable materials and any material that would biodegrade over a relatively short period of time could be used.

Outer camouflage layer 200 may be a non-woven material having a weight, for example, of 10-30 g/m². The odor adsorbing layer 210 may be comprised of active charcoal having a weight of, for example, 20-80 g/m², with a more preferred range of 35-55 and a target for 60 g/m². The inner layer may have a single colour, optionally reflective. The more weight of carbon per square meter means that the carbon layer is thicker and it is more effective for the uses disclosed herein. Too much carbon can impair breathability. In addition, fabrics with too much carbon, e.g., around 100 g/m² would generally be too expensive to be considered disposable and would be more of a type to be reactivated and reused as part of another hunt. The filter layer 220 may have a weight, for example, of 20 g/m². The inner layer 230 may be a non-woven material, having a weight, for example, of 30 g/m². An example of a mask in terms of the layers would be:

Outer layer (camouflage, white, or other color) weight of 16-25 g/m²

Carbon layer weight of 20 to 80 g/m²

Filter layer between 95% Bacteria Filter Efficiency (BFE)(3 microns)-75% BFE (10 microns)

Inner layer 10-20 g/m² (black orange or any other color)

With the disposable mask of the invention, a hunter can travel to the desired hunting locale or site, don the mask for the period of the hunt, e.g., during a stay in a hunting stand or blind or the time period wherein masking of the hunter's breath odor is important for the success of the hunt, and then dispose of the mask in an appropriate waste container. In instances wherein the mask is totally biodegradable, the mask could be left in nature to degrade. A new mask would be used for the next hunting period and/or in the next hunting location, which could be the next day or even later in the same day. The advantage of the low cost disposable mask is that the hunter is assured of maximum adsorption of odors each time a new mask is used as part of the hunt as well as presents no risk to personal hygiene. This contrasts with the prior art mask, that is designed with high amounts of carbon in the mask such that it would be impractical to dispose of the mask after each hunting period.

One or more of the layers of the mask can incorporate other agents to provide additional functionality to the mask over and above the filtering and odor adsorption described above. For example, an antimicrobial agent such as silver ions or silver threads, quats, triclosan and the like can be employed as part of the layer containing the activated carbon or one or more of the other layers.

The layers are preferably attached together in a manner that is cost efficient so that disposability is not comprised. One example is to use adhesives, e.g., a hot melt adhesive, to attach the layers together. This type of attachment would be far superior to sewing the layers together since sewing would require materials for the layers that would be capable of being threaded together, and such materials would increase the cost of the mask such that it could not be sold at a disposable item price. The mask would just be too expensive to be used once and thrown away. This would be like using a cotton dish towel for drying dishes and then throwing the bacteria-laden cotton towel away after every dish drying exercise.

In a preferred mode of manufacture, the inner and outer layers are adhesively bonded together with the filter and carbon layer disposed therebetween. A thermoplastic adhesive and heat can be used to make the bond. For example, two edges of the inner layer can be folded over the outer layer, with two edges of the outer layer folded over the inner layer. Adhesive on each edge would bond with the oppositely facing layer upon application of heat and pressure.

Another aspect of making the disposable masks is that it is preferred that the masks be manufactured in a clean room environment, sterilized, and packaged individually and sealed in an aluminum foil or plastic wrapping.

One or more of the layers could be pleated to provide a better fit to the hunter's face.

FIG. 2B illustrates a cross-section of another embodiment of a hunting mask 105 which is reversible. The hunting mask 105 is comprised of at least five layers. An additional filter layer 220 for filtering our larger particulate matter is placed between the camouflage layer 200 and the odor adsorbing layer 210 and prevents the larger particulate matter from clogging the odor adsorbing layer 210 when the mask 105 is used with the camouflage layer 200 against the hunter's face. The additional filter layer is adapted to filter out particles in the size range of 3-10 microns.

An inner layer 240 may be woven or non-woven fabric comprising cotton, wool, polyester or any suitable fabric. The layer 240 can have a reflective, bright or highly visible colour of so that the hunter will be easily observable by other people, such as other hunters, when the mask 105 is worn with the layer 240 facing outwards. For example, the layer 240 may be colored hunter orange. The inner and/or outer layers can also include other indicia thereon if so desired. For example, indicia representing a hobby, fishing, hunting, or like or a sport, logos of sport teams, Nascar drivers, professional athletes, etc., could be included on one side if the mask is not intended to be reversible or on both sides if reversibility is desired. The outer layer 200 does not have to be camouflage but can be an environmentally suitable color and/or pattern. For example, if the mask is worn during bird watching, the outer layer 200 could have a bird pattern on it. If the mask is used for gardening, flowers or vegetables could be portrayed on the outer layer.

The hunting mask 105 may be worn with the outer camouflage layer 200 outwards when hunting and with the inner reflective layer 240 outwards at other times when the hunter is not trying to conceal themselves from the game, such as when exiting the hunting grounds or when field dressing.

The hunting mask 100 or 105 has an additional or replacement function to that outlined above, in that the mask 100 or 105 at least partially adsorbs and blocks particles from being inhaled by the hunter when the mask is worn over the mouth. That is, the mask can be used for other purposes, some hunting related and some that do not necessarily involve hunting. For example, the mask could be used to filter water when one is in a situation where it is important to mask odor, but not necessarily hunt, e.g., just observing animals. Thus, a person could hike to a remote area for the purpose of observing animals and wear the mask so as not to exhale breath that may make the animals scarce. If such a hike would require water and the hiker would have run out of water, the mask could be used to filter water for consumption.

Other uses of the mask include blocking the odor of dead game during transport, cleaning or other field dressing and at least partially blocking harmful bacteria from being inhaled by the hunter. Pollutants may also be adsorbed and blocked from being inhaled by the hunter. This allows a hunter to both conceal themselves from the game and be protected during transport, cleaning and/or other field dressing of the game without requiring an additional protective mask.

The inventive mask has a number of uses such as: absorbing scents and odors produced by breathing (covering up to 80% of what a human produces); filtering allergens (for people with environmental allergies); filtering bacteria (infectious disease prevention); filtering pollutants, dust and pollen(for overall wellbeing); keeping one alert on a hunting stand as you are breathing clean air (safety); filtering out odors during field dressing process helps control gag factor); filters out bacteria's during field dressing (disease prevention); keeping one's temperature regulated as your heat from breathing is contained; orange model provides hunter identification.(for safety); keeping the sound of your breathing and coughing muffled down so as not to scare away your quarry; helps to prevent you from coughing period as you are no longer breathing dry air; providing camouflage break-up for your face; helping to control wind burn and frostbite on face helps to control chapped lips; allowing hunters who wear glasses a means of covering their face without fogging their glasses; emergency fire starter (kindling); use for odor adsorbing insoles for boots; use to clean your knife and hands off after field dressing process; emergency water container; emergency first aid gauze to stop bleeding; hand cloth; camera or binocular lens cleaner; light blocking sleeping aid for eyes as well as emergency eye patch; car freshener (adsorbs odors in your car); dust cloth; hunting closet filter and odor adsorber; hat to block sun's harmful rays; waterproof camera protector and camouflage cover; crumple individual plastic packaging to imitate squirrel rustling in leaves for still hunting; individual packaging to be used to pick up and store scent wicks; break-up for tree stands; use for a deer decoy tail (will move when the wind blows, scent pad for decoy; scent dispersal system; emergency toilet paper; tissue for blowing nose; flashlight dimmer; can be tied together to make clothing, can be used to plug a hole in a canoe; quick oven mitt for pulling a hot can of beans off of a fire; food dish, separate and use black layer to make sun glasses, wind break for face while riding ATV or other vehicle, soak carbon material in water and drink to cure food poisoning; cold compress for fevers; wind sock to determine wind direction; tear apart to use as rifle cleaning patches; tear apart to use white filter media as a trail marker, extract wire to use as a tie wire (twist tie) or electrical repair device; extract wire to make a floating compass; extract wire to make a fish hook; extract wire to make a snare; extract wire to use as a cauterizing tool just pull wire jacket back half way to hold; extract wire, heat it up to burn a precision hole in your fingernail to relieve pressure if you have suffered an impact; extract wire fold it in half to use as a fingernail cleaner; use elastics for rope or fishing line; use elastics to make a tourniquet to stop bleeding; use elastic as a candle wick if you have any gas or kerosene; use elastic as a slow burning fuse; use several masks on face and exposed areas to protect from black flies; use the adsorbing qualities of the adsorbent and/or the filter to interact with exhaled breath so that the user's breath does not act as an insect attractant; use as a towel to whisk water off your body if you fall through the ice and need to dry off quick; tie two masks together to make ear muffs; makes a good water proof container for matches or pieces of food (meat); use elastics and wire as a needle and thread; tear apart to access white filter material for writing paper to leave a message; hang in a tree to use as a rainwater collection system, roll up to put in your mouth as a biting pad to deal with painful first aid techniques (like sawing off your arm); use the mask as an emergency toothbrush; use wire as a toothpick; use to wipe mud from boots before storing boots away from a hunt; use as a silencing device to shim up a squeaky tree stand; use as a breathable worm container lid for fishing by placing over a jar and then securing with elastics; use as silent stalking slippers on your way to the tree stand, use as an ice pack holding compress; use to make a bola weapon with a two piece of rope; use as a tent repair patch; use as an odor adsorbing woman's panty shield in bear country during menstruation; hang used masks in tree branches to create a leafy break-up; put in dryer to adsorb clothing odors, put used masks in scent free bags to continue adsorbing clothing odors; use as water resistant knee pads while still hunting or gardening; use as camouflage cover for your hand if you drop a glove from your tree stand; use elastics to make a friction fire bow; use as a camouflage beer can or bottle insulation wrap/ cooler; tear apart to expose white material to use as a surrender flag; use plastic bag to stop suction on a puncture wound of the lungs; prevent the inhalation of depleted uranium dust; rip apart to expose white filter media, write a daily log and tie together to make a custom diary; burn elastics to create a hot glue substance for making unexpected water repellent repairs; use elastics to make a makeshift bow and wire to install head to arrow shaft; women could use two to make an emergency bra or underwear; men could use for emergency underwear, use elastics for an emergency hair tie; use wire for bug cooking device in an emergency; use for grasping, hot or sharp objects; use for making sticky bombs as seen on “Saving Private Ryan”; use wire to short out a battery to start a fire; use wire as a lock pick; use wire as a safety pin; use elastic as a shoelace; stick wire in ground for use as a makeshift sundial to tell the time; tear apart to expose white filter material and use as high contrast to flag down an airplane ; visor to keep sun out of your eyes; use black carbon layer to filter stagnant water ;good for sponge bath for personal hygiene in the field; tear off camouflage layer to produce a butterfly stitch for bleeding wounds; use elastics to hold in place; lab test masks for DNA mapping and analysis of environmental contaminants or airborne bio hazardous weapons; pull mask elastics apart tight and you have an approximate two foot measuring reference; disposable dish cloth at camp; disposable weapons cleaning; disposable coffee cup; use around the house for drywall repairs, gardening etc.; use to camouflage your headlights and tail lights of a vehicle such as an ATV; use for the administering of drugs, especially unscented drugs, via inhalation such as menthol, antihistamines etc.; and mask can be used to be optionally bio degradable and loaded with seeds formulated to be bait or food for the deer.

The present invention has been described with regard to a plurality of illustrative embodiments and examples. However, it will be apparent to persons skilled in the art that a number of variations and modifications can be made without departing from the scope of the invention as defined in the claims.

We claim:

1. An outdoors mask for at least absorbing a user's breath odor, the mask comprising:
an exterior layer,
an odor adsorbing layer for absorbing odor and odor causing particles in a user's breath,
a first filter layer for filtering particulate matter expelled from the user's mouth or from being inhaled by the user,
an inner layer suitable for placement over a user's mouth, and
an attachment strap for securing the outdoors mask over the mouth of a user,
wherein the layers and attachment strap are held together and made of materials such that the mask can be used one or several times and then disposed.

2. The outdoors mask of claim 1, further comprising:
an adhesive bond between at least the outer layer and the inner layer.

3. The outdoors mask of claim 2, wherein the first filter layer filters out particulate matter as small as 3 microns in size.

4. The outdoors mask of claim 1, wherein the odor absorbing layer comprises activated charcoal.

5. The outdoors mask of claim 1, wherein the odor absorbing layer comprises activated charcoal having a weight of 45 g/m².

6. The outdoors mask of claim 1, further comprising:
a first filter layer between the odor adsorbing layer and the inner layer for blocking larger particles from the odor adsorbing layer, and
wherein the exterior layer has a weight of about 16-25 g/m², the odor absorbing layer comprises activated charcoal having a weight of about 20-60 g/m², the filter layer having a filtering capability between 3 and 10 microns, and the inner layer has a weight of about 10-30 g/m².

7. The outdoors mask of claim 1, wherein the attachment strap comprises a strap connected to each side of the mask adapted for hooking placement around the ears of a user.

8. The outdoors mask of claim 1, further comprising:
a second filter layer between the exterior layer and the odor absorbing layer for blocking particulate matter from the odour absorbing layer,
wherein the inner layer has a reflective surface and the mask is reversible.

9. The outdoors mask of claim 1, wherein the mask is pleated to conform to a user's chin and jaw to obtain a tight fit.

10. The outdoors mask of claim 1, wherein the attachment strap is made from elastomeric material.

11. The outdoors mask of claim 1, wherein the mask is individually packaged in a container and is sterile when in the container prior to opening.

12. A reversible outdoors mask for absorbing a user's breath odor, the mask comprising:
a camouflage exterior layer,
an odor absorbing layer for absorbing odour and odor causing particles in a user's breath,
an inner reflective layer suitable for placement over a user's mouth,
a first filter layer between the camouflage exterior layer and the odor absorbing layer for filtering particulate matter expelled from the user's mouth or from being inhaled by the user;
a second filter layer between the inner reflective layer and the odor adsorbing layer for blocking particulate matter from the odor adsorbing layer; and
an attachment strap for securing the outdoors mask over the mouth of a user,
wherein the layers and attachment strap are held together and made of materials such that the mask can be used one or several times and then disposed.

13. The reversible outdoors mask of claim 12, wherein the first filter layer and/or the second filter layer filter out particulate matter as small as 3 microns in size.

14. The reversible outdoors mask of claim 12, wherein the reflective layer is hunter orange.

15. The reversible outdoors mask of claim 12, wherein the mask is pleated to conform to a user's chin and jaw to obtain a tight fit.

16. The outdoors mask of claim 12, wherein the attachment strap is made form elastomeric material.

17. The outdoors mask of claim 12, wherein the mask is individually packaged in a container and is sterile when in the container prior to opening.

18. The outdoors mask of claim 12, wherein the exterior layer has a weight of about 16-25 g/m², the odor absorbing layer comprises activated charcoal having a weight of about 20-60 g/m², the first and second filter layers each having a filtering capability between 3 and 10 microns, and the inner layer has a weight of about 10-30 g/m²

19. A method of hunting game, wherein a hunter travels to a hunting environment to hunt game, comprising:
donning a mask to cover a mouth of the hunter during a period of the hunt, the mask containing an adsorbent to adsorb odors emanating from the hunter's mouth and at least one filter configured to prevent particulate material of 10 micron size or greater from entering the hunter's mouth, and
disposing of the mask upon termination of the hunt period and donning another mask for a subsequent hunt period.

20. The method of claim 19, wherein the mask comprising:
an exterior layer,
an odor adsorbing layer for absorbing odor and odor causing particles in a user's breath,
a first filter layer for filtering particulate matter expelled from the user's mouth or from being inhaled by the user,
an inner layer suitable for placement over a user's mouth, and
an attachment strap for securing the outdoors mask over the mouth of a user, wherein the layers and attachment strap are held together and made of materials such that the mask is disposable, is donned.
